(19) United States
(12) Patent Application Publication
(10) Pub. No.: US 2008/0087685 A1
(43) Pub. Date: Apr. 17, 2008

(54) Push Button For Actuating A Member For Dispensing A Fluid Product And Method Of Producing Such A Push Button

(76) Inventor: Richard Bloc, Derchigny-Graincourt (FR)

Correspondence Address: ST. ONGE STEWARD JOHNSTON & REENS, LLC, 986 BEDFORD STREET, STAMFORD, CT, 06905-5619, US

(21) Appl. No.: 11/871,555

(22) Filed: Oct. 12, 2007

(30) Foreign Application Priority Data
Oct. 13, 2006 (FR) 06 09022

(51) Int. Cl. B65D 88/54; B23P 11/00

(52) U.S. Cl. 222/320; 29/428

(57) ABSTRACT

Push button comprising a body comprising a bearing wall and an annular lateral wall that extends from the bearing wall to a free end and has an external surface, a flow duct that extends into the body and leads to the outside via an outlet member protruding relative to the external surface of the lateral wall, an annular covering element covering the external surface of the lateral wall and fixedly attached to the body, the covering element being placed beneath the outlet member and being suitable for being fitted onto the lateral wall via the free end of the lateral wall.

### CROSS-REFERENCE TO RELATED APPLICATIONS

The present application claims priority of French patent application No. 06 09022 filed on Oct. 13, 2006, the content of which is incorporated herein by reference.

### FIELD OF THE INVENTION

The invention relates to a push button for actuating a member for dispensing a fluid product and to a method for producing such a push button.

### BACKGROUND OF THE INVENTION

In particular, the invention relates to a push button for actuating a member for dispensing a fluid product, comprising:

a body comprising a bearing wall suitable for receiving a finger of a user and an annular lateral wall that extends from the bearing wall to a free end, said lateral wall having an external surface,

a fluid product flow duct that extends into the body and leads to the outside via an outlet member protruding relative to the external surface of the lateral wall,

an annular covering element at least partially covering the external surface of the lateral wall and fixedly attached to the body.

In a known push button of this type, the body has an open housing on the lateral wall. The covering element is suitable for being mounted on the lateral wall via the bearing wall and has an orifice placed so as to face the housing. The outlet member is in the form of a separate nozzle fitted into the housing through the orifice.

The mounting of the covering element onto the body has risks of trapping the bearing wall in the covering element. Furthermore, a non-alignment between the orifice of the covering element and the housing may render the fitting of the nozzle impossible.

Furthermore, the push button as described above does not make it possible to adapt the steps of manufacturing the push button. Actually, such a push button requires that the nozzle be fitted into the housing after the covering element has been mounted onto the body.

### SUMMARY OF THE INVENTION

The invention aims to solve the problems mentioned above.

Accordingly, the invention proposes a push button of the type mentioned above wherein the covering element is placed beneath the outlet member and is suitable for being fitted onto the lateral wall via the free end of said lateral wall.

In this manner, the outlet member can be associated with the body independently of the relative positioning of the covering element and the body. And this association can take place before or after the covering element is mounted onto the body.

Furthermore, the lateral wall has a greater capability to deform at the free end than at the bearing wall, which limits the risks of trapping during the mounting of the covering element.

In particular embodiments, the push button may have, in a complementary manner where necessary, one or more of the following arrangements:

the outlet member is made in one piece with the body: this simplifies the production of the push button by limiting the number of steps and by allowing a mounting in a single direction,

the external surface of the lateral wall has a peripheral shoulder oriented towards the free end, the covering element being in abutment against the said shoulder.

Furthermore, a further subject of the invention is a method for producing a push button as described above, comprising the following steps:

forming a body comprising a bearing wall and an annular lateral wall that extends from the bearing wall to a free end, said lateral wall having an external surface,

associating with the body an outlet member protruding relative to the external surface of the lateral wall,

forming a fluid product flow duct that extends into the body and leads to the outside via the outlet member,

fitting an annular covering element onto the lateral wall via the free end of said lateral wall.

In one embodiment, the formation of the body, the association with the body of the outlet member and the formation of the flow duct may be carried out in a single moulding step.

### BRIEF DESCRIPTION OF THE DRAWINGS

Other objects and advantages of the invention will appear on reading the following description, made with reference to the appended drawings in which:

FIG. 1 is a representation in perspective of a dispenser comprising a push button according to one embodiment of the invention,

FIG. 2 is a representation in longitudinal section of the push button of FIG. 1 mounted on a dispensing member,

FIG. 3 is a representation in longitudinal section of the push button of FIG. 1.

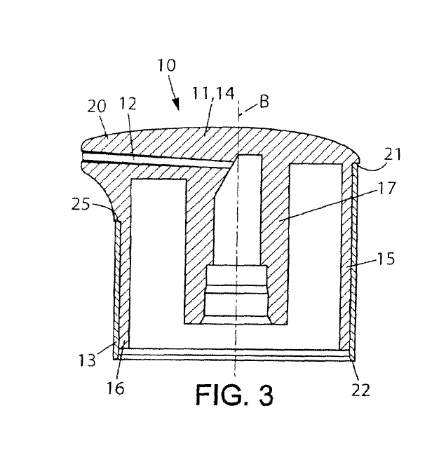

### DETAILED DESCRIPTION OF THE INVENTION

In the figures, the same reference numbers indicate identical or similar elements.

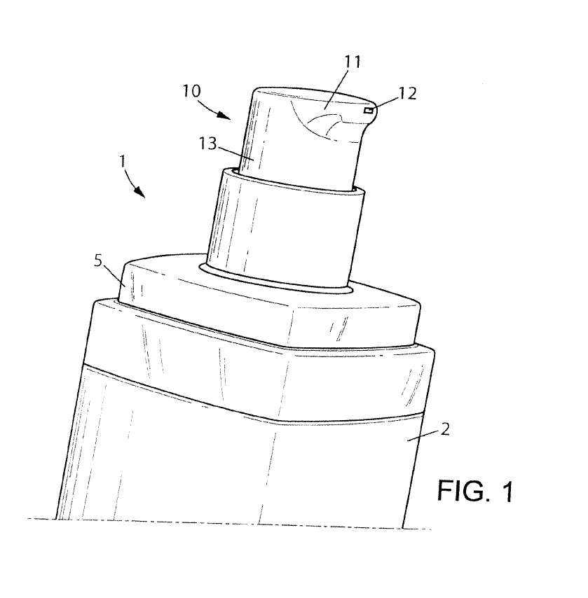

FIG. 1 represents a dispenser 1 allowing the dispensing of a fluid product and, for example, of a cream or a gel from the field of cosmetics, pharmaceuticals, perfumery or another.

The dispenser 1 comprises a reservoir 2 inside which the fluid product is placed. The reservoir has in particular a bottom, a lateral wall and an opening opposite the bottom.

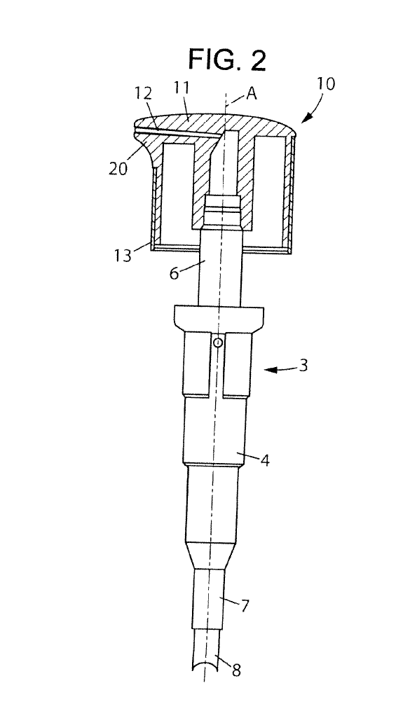

A manually actuatable dispensing member 3, shown in FIG. 2, is mounted, by means of an attachment member 5, in the opening of the reservoir 2 so as to be able to draw off some of the fluid product from inside the reservoir 2 and deliver it to the outside.

In the rest of the description, the terms “bottom” or “lower” and “top” or “upper” will be understood with reference to the orientation of the reservoir 2 resting on the bottom. Furthermore, the terms “upstream” and “downstream” will be understood with reference to the direction of travel of the fluid product from the inside of the reservoir 2 to the outside.

In particular, the dispensing member 3 may comprise a tubular body 4 that extends along an axis A and a stem 6 mounted in an open top end of the body 4. The stem 6 can be moved partly inside the body 4 in translation along the axis A. A bottom end of the body 4, also open, is in fluidic communication with the reservoir 2, for example by means of a tubular attachment wall 7 receiving a dip tube 8 by fitting.

In a particular example, the dispensing member 3 may be a pump comprising a compression chamber delimited by an inlet valve close to the second end of the body 4, an outlet valve and a piston fixedly attached to a bottom end of the stem 6 and able to be moved in a sealed manner inside the body 4.

To actuate the dispensing member 3 by moving the stem 6 inside the body 4, a push button 10 may be mounted on a top end of the stem 6.

The push button 10 comprises a body 11, a flow duct 12 in fluidic communication with the dispensing member 3 and a covering element 13.

The body 11 of the push button 10, made for example of plastic, comprises a bearing wall 14 suitable for receiving a finger of a user and an annular lateral wall 15 that extends from the bearing wall 14 to a free end 16.

As shown in the figures, provision can be made for the body 11 to be cylindrical along a longitudinal axis B. The bearing wall 14 may extend substantially radially relative to the longitudinal axis B. The lateral wall 15 may extend substantially axially from the bearing wall 14 and have an internal surface and an external surface that are substantially cylindrical.

As a variant, it is however possible to provide that the surfaces of the bearing wall 14 and lateral wall 15 have inclined, curved, axial zones or a combination of such zones and that the body 11 has a shape other than cylindrical.

Furthermore, the body 11 may comprise internally an attachment socket 17 that extends along the axis B from the bearing wall 14 in order to allow the mounting of the push button 10 onto the stem 6 coaxially with the axis A. The attachment socket 17 delimits a supply channel in fluidic communication with the stem 6 of the dispensing member 3.

The flow duct 12 extends into the body and leads to the outside via an outlet member 20 protruding relative to the external surface of the lateral wall 15. In the figures, the flow duct 12 extends in a direction that is transverse relative to the longitudinal axis B between an upstream end that leads into the supply channel and a downstream end provided in the outlet member 20.

In the embodiment shown, the outlet member 20 is made in one piece with the body 11. For example, the bearing wall 14 may comprise the outlet member 20 extending transversely and the flow duct 12 may be formed in the bearing wall 14. As a variant, provision may be made for the outlet member 20 to be made in one piece with a top portion of the lateral wall 15 situated close to the bearing wall 14.

In other embodiments, the body 11 may have an open housing on a top portion of the lateral wall 15 close to the bearing wall 14 and the outlet member 20 may be a separate nozzle fitted into the housing.

The covering element 13 is annular and at least partially covers the external surface of the lateral wall 15. In particular, the covering element 13 extends between an upper edge 21 close to the bearing wall 14 and a lower edge 22 opposite the upper edge 21. The covering element 13 has an external surface and an internal surface.

The covering element 13 is placed beneath the outlet member 20, that is to say that the upper edge 21 delimits a through-opening into which the lateral wall 15 may extend, at least a portion of the upper edge 21 passing under the outlet member 20.

The covering element 13 is suitable for being nested onto the lateral wall 15 via the free end 16 of the lateral wall. The internal surface of the covering element 13 is also suitable for receiving at least a lower portion of the lateral wall 15 of the push button 10 and for fixedly attaching the covering element 13 to the said lateral wall 15.

For example, in the embodiment shown, the internal surface of the covering element 13 has a transverse dimension and shape that are substantially similar to those of the external surface of the lateral wall 15. Similarly, the upper edge 21 of the covering element 13 is placed beneath the bearing wall 14 and has a transverse dimension and shape that are substantially similar to those of the external surface of the lateral wall 15. The covering element 13 is then held by fitting with radial clamping relative to the longitudinal axis B on the lateral wall 15.

Provision may however be made, in other embodiments, for the covering element 13 to be held on the lateral wall 15 either by radial clamping of some or all of the upper edge 21 of the covering element 13 and/or by radial clamping of some or all of the internal surface of the covering element 13.

To ensure the relative positioning of the covering element 13 and the body 11, the external surface of the lateral wall 15 of the body may have a peripheral shoulder 25 oriented towards the free end 16, the upper edge 21 of the covering element 13 being in abutment against the shoulder 25. The covering element 13 may have a thickness between the external surface and the internal surface that is substantially equal to a dimension measured transversely relative to the longitudinal axis B of the shoulder 25.

In the figures, the shoulder 25 is made under the bearing wall 14 and under the outlet member 20 and the covering element 13 has a dimension measured along the longitudinal axis B that is substantially equal to or greater than that of the lateral wall 15, the upper edge 21 forming locally a notch made axially to allow the outlet member 20 to pass through. In this manner, the covering element 13 may cover virtually the whole of the lateral wall 15 of the body 10, the bearing wall 14 and the outlet member 20 protruding relative to the through-opening.

However, provision may be made for the shoulder 25 and/or the dimension along the longitudinal axis B of the covering element 13 to be such that the covering element 13 covers only a lower portion of the lateral wall 15 situated at a distance from the bearing wall 14.

The covering element 13 makes it possible to improve the mechanical and chemical resistance of the push button 10 and to modify its external appearance. Depending on the desired application of the push button 10, the covering element 13 may be made of metal, for example aluminium that is polished and then anodized for a gold or chrome appearance, or made of plastic, for example with elements such as colour or other pigments distributed in the material.

Such a push button may be made simply, for example by the application of a method making provision to:

form the body 11,

associate with the body 11 the outlet member 20 protruding relative to the external surface of the lateral wall 15,

form a fluid product flow duct 12 that extends into the body 11 and leads to the outside via the outlet member 20,

fit the annular covering element 13 onto the lateral wall 15 via the free end 16 of said lateral wall 15.

For the push button 10 represented in the figures, the formation of the body 11, the association with the body 11 of the outlet member 20 and the formation of the flow duct 12 may be achieved in a single moulding step, particularly by injection of a plastic.

In the embodiment according to which the outlet member 20 is a separate nozzle, the association of the outlet member 20 and the formation of the flow duct 12 may take place before or after the step of fitting the covering element 13.

In particular, in the case of a separate nozzle, the nozzle and the body 11 may each comprise a portion of the flow duct 12 and the formation of the flow duct 12 is obtained by assembling the two portions during the association of the nozzle with the body 11. Provision may also be made for only the nozzle to comprise the flow duct 12 or for the flow duct 12 to be made in the nozzle after the association of the nozzle with the body 11.

1. Push button for actuating a member for dispensing a fluid product, comprising:
a body comprising a bearing wall suitable for receiving a finger of a user and an annular lateral wall that extends from the bearing wall to a free end, said lateral wall having an external surface,
a fluid product flow duct that extends into the body and leads to the out-side via an outlet member protruding relative to the external surface of the lateral wall,
an annular covering element at least partially covering the external surface of the lateral wall and fixedly attached to the body,
wherein the covering element is placed beneath the outlet member and is suitable for being fitted onto the lateral wall via the free end of said lateral wall.

2. Push button according to claim 1, wherein the outlet member is made in one piece with the body.

3. Push button according to claim 1, wherein the external surface of the lateral wall has a peripheral shoulder oriented towards the free end, the covering element being in abutment against the said shoulder.

4. Method for producing a push button according to claim 1, comprising the following steps:
forming a body comprising a bearing wall and an annular lateral wall that extends from the bearing wall to a free end, said lateral wall having an external surface,
associating with the body an outlet member protruding relative to the external surface of the lateral wall,
forming a fluid product flow duct that extends into the body and leads to the outside via the outlet member,
fitting an annular covering element onto the lateral wall via the free end of said lateral wall.

5. Method for producing a push button according to claim 4, wherein the formation of the body, the association with the body of the outlet member and the formation of the flow duct are carried out in a single moulding step.

6. Push button according to claim 2, wherein the external surface of the lateral wall has a peripheral shoulder oriented towards the free end, the covering element being in abutment against the said shoulder.
